(19) United States
(12) Patent Application Publication
(10) Pub. No.: US 2026/0267993 A1
(43) Pub. Date: Sep. 10, 2026

(54) AI-Powered Risk Analysis and Approval Workflow for Containerized Application Deployments

(71) Applicant: Oracle International Corporation, Redwood Shores, CA (US)

(72) Inventors: Payal Godhani, Sammamish, WA (US); Pruthvi Muthyam, Austin, TX (US); Vivekananda Kodancha, Bengaluru (IN)

(73) Assignee: Oracle International Corporation, Redwood Shores, CA (US)

(21) Appl. No.: 19/223,629

(22) Filed: May 30, 2025

Related U.S. Application Data
(60) Provisional application No. 63/768,476, filed on Mar. 7, 2025.

(51) Int. Cl. G06F 21/57; G06F 8/60

(52) U.S. Cl. CPC G06F 21/577; G06F 8/60

(57) ABSTRACT

Techniques for reducing the number of high-risk deployments that negatively impact critical resources of a computer system are disclosed. One or more embodiments provide two different deployment workflows for deploying containerized applications to a container orchestration platform. A first deployment workflow requires a first set of approvers. A second deployment workflow requires a second set of approvers. One or more embodiments train a machine learning model to evaluate a deployment manifest for a target deployment and determine if the deployment is a high-risk deployment. If the deployment is not high risk, then the system executes the first deployment workflow. If the deployment is high risk, then the system executes the second deployment workflow.

### BENEFIT CLAIMS; RELATED APPLICATIONS; INCORPORATION BY REFERENCE

This application claims the benefit of U.S. Provisional Patent Application No. 63/768,476, filed Mar. 7, 2025, entitled “AI-Powered Risk Analysis and Approval Workflow for Kubernetes Deployments,” which is hereby incorporated by reference in its entirety as if set forth herein.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to software deployment. In particular, the present disclosure relates to reducing the number of high-risk deployments that negatively impact critical resources of a computer system.

### BACKGROUND

Software deployment makes a software application or update available for use in a specific target environment, such as a server or client device. A container orchestration platform (e.g., Kubernetes) supports the deployment, management, and scaling of containerized applications. Deploying an application to a container orchestration platform introduces the risk of potentially deleting or misconfiguring a critical resource (e.g., a critical application, service, or data repository, such as a credential database or load balancer) and/or a resource on which a critical resource depends. A deployment that risks deleting or misconfiguring a critical resource and/or a resource on which a critical resource depends is a high-risk deployment.

Deploying an application to a container orchestration platform uses a deployment manifest (e.g., a YAML or JSON file) that declares the target state (e.g., specific pods and containers) of the environment (e.g., cluster) to which the application is being deployed. Based on the manifest, the deployment process reconciles the target environment's current state with the target state and performs the operations necessary for the target environment to reach the target state. These operations may delete or reconfigure an existing resource in the target environment, creating the potential for a high-risk deployment.

A cloud service provider may host a container orchestration platform and allow customers to deploy custom applications to the platform. However, deployment manifests can be configured in many ways, and a cloud service provider does not always have insight into the manifest configurations that its customers will use. In such cases, the cloud service provider cannot proactively identify a high-risk deployment before the deployment process begins.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for training a machine learning (ML) model to reduce the number of high-risk deployments in accordance with one or more embodiments;

FIG. 3 illustrates an example set of operations for using an ML model to reduce the number of high-risk deployments in accordance with one or more embodiments;

FIG. 4 illustrates an example graphical user interface (GUI) for creating a software release for deployment in accordance with one or more embodiments;

FIG. 5 illustrates an example GUI for alerting a user to the existence of a high-risk deployment in accordance with one or more embodiments;

FIG. 6 illustrates a machine learning engine in accordance with one or more embodiments;

FIG. 7 illustrates an example set of operations of an ML engine in accordance with one or more embodiments;

FIGS. 8-11 are block diagrams illustrating patterns for implementing a cloud infrastructure as a service system in accordance with one or more embodiments; and

FIG. 12 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

In most cases, the CSP is a third-party service that specializes in providing (e.g., offering, renting, selling) cloud services to customers. The servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, an entity might opt to deploy a private cloud, becoming its own provider of cloud services. In some instances, an entity may utilize both a private cloud and a public cloud provided by a third-party CSP, thereby forming a hybrid cloud.

There are several cloud service providers that offer various types of cloud services. There are different types or models of cloud services, including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity. When a customer subscribes to or registers for a service provided by a CSP, a tenancy or an account is created for that customer. The customer can then, via this account, access the subscribed-to one or more cloud resources associated with the account.

### TABLE OF CONTENTS

1. GENERAL OVERVIEW
2. DEPLOYMENT RISK REDUCTION ARCHITECTURE
3. REDUCING HIGH-RISK DEPLOYMENTS
4. EXAMPLE EMBODIMENT
5. PRACTICAL APPLICATIONS, ADVANTAGES, AND IMPROVEMENTS
6. MACHINE LEARNING ARCHITECTURE
7. CLOUD COMPUTING TECHNOLOGY
8. COMPUTER SYSTEM
9. MISCELLANEOUS; EXTENSIONS

### 1. General Overview

One or more embodiments provide two or more different deployment workflows for deploying containerized applications to a container orchestration platform. A first deployment workflow requires a first set of approvers (e.g., an approver at a particular authorization level). A second deployment workflow requires a second set of approvers. The second deployment workflow may require a completely different set of approvers, or may have the same requirement as the first deployment workflow plus one or more additional approvers at a higher authorization level.

One or more embodiments train a machine learning (ML) model to evaluate a deployment manifest and determine if the deployment is a high-risk deployment. If the deployment is not high risk, the system executes the deployment using the first deployment workflow. If the deployment is high risk, the system executes the deployment using the second deployment workflow.

In one or more embodiments, the first deployment workflow does not include any approvers. Based on the output of the ML model, a critical path module determines that the deployment can proceed without requiring human approval.

One or more embodiments include a second ML model that generates a human-readable explanation of why a particular deployment is high-risk. If, based on the output of the first ML model, the system determines that a deployment is high-risk, the system uses the second ML model to generate an explanation for the deployment being high-risk. The system incorporates the explanation into the second deployment workflow (e.g., by presenting the explanation to one or more of the approvers in the second deployment workflow). In an embodiment, the first ML model and the second ML model may be components of a single model, in which case determining if a deployment is high-risk and generating an explanation may be performed in response to a single ML prompt.

One or more embodiments described in this Specification and/or recited in the claims may not be included in this General Overview section.

### 2. Deployment Risk Reduction Architecture

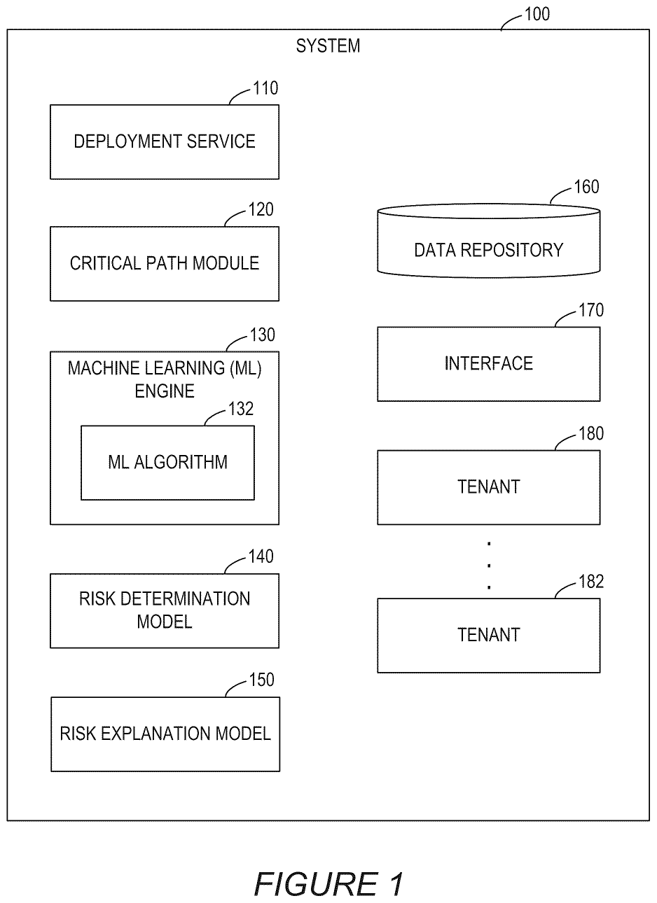

FIG. 1 illustrates a system 100 in accordance with one or more embodiments. As illustrated in FIG. 1, system 100 includes a deployment service 110, a critical path module 120, a machine learning (ML) engine 130, a risk determination model 140, a risk explanation model 150, a data repository 160, an interface 170, and tenants 180 and 182. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the system 100 is a cloud computing service (also referred to as a cloud service. The term “cloud computing service” or “cloud service” is generally used to refer to a service that is made available by a cloud services provider (CSP) to users or customers on demand (e.g., via a subscription model) using systems and infrastructure (cloud infrastructure) provided by the CSP.

In an embodiment, the system 100 includes a container orchestration platform that supports the deployment, management, and scaling of containerized applications. Containerized applications may include applications that run inside a container. A container is a lightweight, portable, and isolated environment that packages the application code along with everything it needs to run, which may include libraries, dependencies, configuration files, and runtime.

In some embodiments, the container orchestration platform implemented by the system 100 is a multi-tenant platform hosted by a cloud service provider. The multi-tenant platform may include multiple tenants having corresponding target environments associated with them (e.g., a first target environment associated with a first tenant, a second target environment associated with a second tenant, etc.). The components of system 100 and their functions may be implemented by a service provided and managed by the cloud service provider.

In one or more embodiments, a tenant (such as tenant 180 and/or tenant 182) is a corporation, organization, enterprise, or other entity that accesses a shared computing resource such as the other components of system 100 illustrated in FIG. 1. In an embodiment, tenant 180 and tenant 182 are independent from each other. A business or operation of tenant 180 is separate from a business or operation of tenant 182.

In one or more embodiments, the deployment service 110 includes one or more tools for deploying applications and services within a cloud infrastructure, on-premise environments, or other computing environments. The deployment service 110 may automate and manage the process of delivering software from development to production environments. In an embodiment, the deployment service 110 uses interface 170 to provide a visual front-end that allows users to interact with and manage the deployment process without relying solely on command-line tools or configuration files. For example, the deployment service 110 may use the interface 170 to provide a dashboard view that displays current deployment status across environments (e.g., development, staging, production).

The deployment service 110 may also use the interface 170 to provide configuration management user interface (UI) tools to enable users to set or edit deployment configurations. In some embodiments, users interact with the deployment service 110 via the interface 170 to define deployment configurations for an application that they want to deploy. The deployment service 110 uses the user input provided by users in defining the deployment configurations to create corresponding deployment manifests. In an embodiment, a deployment manifest includes a configuration file (e.g., in YAML or JSON) that specifies how an application should be deployed, such as by defining resources, configurations, and behaviors for deployment. In an embodiment, the deployment manifest includes a package (e.g., a Helm chart) that bundles the resources needed to deploy an application to a target location (e.g., a target cluster).

In one or more embodiments, interface 170 refers to hardware and/or software configured to facilitate communications between a user and system 100. Interface 170 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 170 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 170 is specified in one or more other languages, such as Java, C, or C++.

In some embodiments, the critical path module 120 includes a software component that is configured to determine a deployment workflow for a target deployment. A deployment workflow is a defined, repeatable sequence of steps, processes, or tasks that automates how software is released and delivered to various environments. A deployment workflow may take software code from a development environment to a production environment or to some other target environment. Deployment workflows may include a variety of stages, including, but not limited to, artifact creation, deployment approval, and production deployment. Artifact creation includes a process of packaging application code and its dependencies into a deployable unit that can be consistently and reliably deployed to different environments. Deployment approval is a control step in the software deployment process where a designated person or group (e.g., a team leader, manager, or quality assurance engineer) is required to manually review and approve a deployment before it proceeds to a specific environment. Production deployment includes pushing the latest, tested, and approved code or application build to a production environment, thereby making it available to end-users.

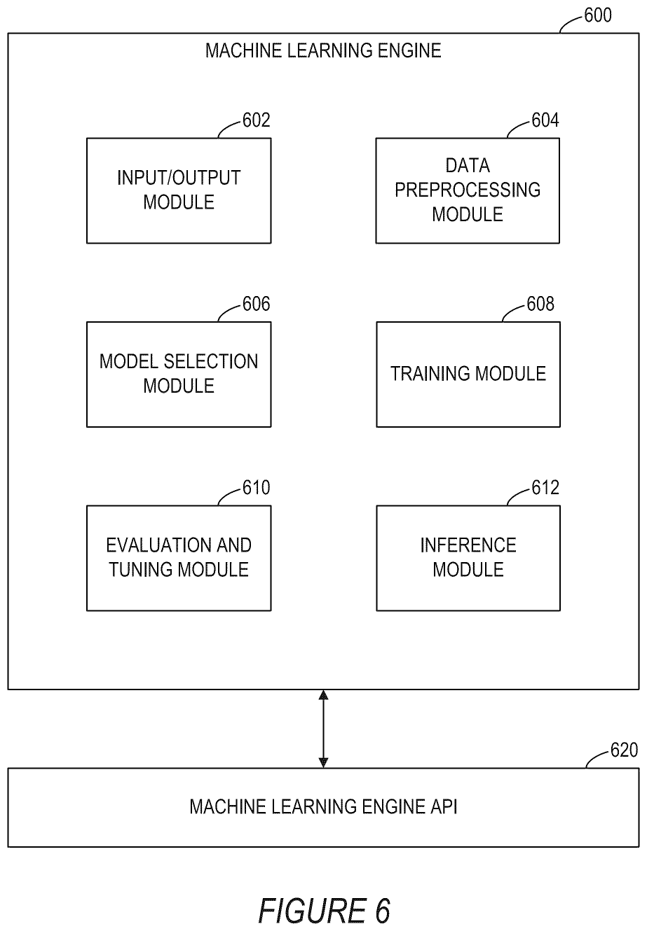

In an embodiment, the ML engine 130 includes a platform or system designed to build, train, deploy, and manage ML models. The ML engine 130 may perform a variety of functions, including, but not limited to, data handling, model training, hyperparameter tuning, model deployment, and model monitoring and management. Data handling may include importing, storing, and preprocessing large datasets. Model training may include teaching ML models to make predictions or decisions by learning patterns from data. Hyperparameter tuning may include the process of finding the best set of hyperparameters for an ML model to improve its performance. Model deployment may include the process of making a trained ML model available in a production environment where it can be used to make real-world predictions on new, unseen data. Model monitoring and management may include tracking the performance of an ML model over time and supporting the modification or rollback of an underperforming ML model. The ML engine 130 may include the features of the ML engine 600 in FIG. 6. However, other implementations of the ML engine 130 are also within the scope of the present disclosure.

In some embodiments, the ML engine 130 includes an ML algorithm 132 that is configured to generate and/or train the risk determination model 140 and the risk explanation model 150. In an embodiment, the ML algorithm 132 includes a gradient-boosting algorithm (e.g., Extreme Gradient Boosting). A gradient-boosting algorithm is an ML algorithm that combines the predictions of multiple weak learners (e.g., decision trees) to create a strong predictive model. The gradient-boosting algorithm works by sequentially building models that focus on the errors of previous models, gradually improving the overall accuracy. This iterative process, also known as boosting, aims to minimize the loss function through the adjustment of model parameters based on the gradient of the error.

In one or more embodiments, the ML algorithm 132 is configured to train the risk determination model 140 to evaluate a deployment manifest associated with a target deployment of an application to a target environment and determine if the target deployment is a high-risk deployment. Based on the risk determination model 140's classification of the target deployment as high-risk or not high-risk, the critical path module 120 may determine a particular deployment workflow for the target deployment. This particular deployment workflow may then be executed by the deployment service 110. For example, if the risk determination model 140 determines that the target deployment is high risk, then the critical path module 120 may select, or otherwise determine, a first deployment workflow for the target deployment to be executed by the deployment service 110. If the risk determination model 140 determines that the target deployment is not high-risk, then the critical path module 120 may select, or otherwise determine, a second deployment workflow for the target deployment to be executed by the deployment service 110. The different deployment workflows may involve different quantities of approvals and/or different authorization levels for approvals. For example, a first deployment workflow may require a first set of approvers (e.g., an approver at a particular authorization level), while a second deployment workflow may require a second set of approvers. The second deployment workflow may require a completely different set of approvers as the first deployment workflow, or may have the same requirement as the first deployment workflow plus one or more additional approvers at a higher authorization level than the first set of approvers.

In an embodiment, the machine learning algorithm 132 is configured to train the risk explanation model 150 to evaluate a deployment manifest associated with a target deployment of an application to a target environment and generate a human-readable explanation of why the target deployment is high-risk. The risk explanation model 150 may be used to generate the human-readable explanation in response to a determination by the risk determination model 140 that the target deployment is high-risk. In some embodiments, the determination, by the risk determination model 140, that the target deployment is high-risk triggers the risk explanation model 150 to generate the human-readable explanation for the target deployment being high-risk and causes the deployment service 110 to incorporate the explanation into the deployment workflow it executes for the high-risk deployment. For example, the deployment service 110 may present the explanation to one or more of the approvers involved in the deployment workflow for the target deployment.

In one or more embodiments, data repository 160 is any type of storage unit and/or device (e.g., a file system, database, collection of tables, or any other storage mechanism) for storing data. Furthermore, data repository 160 may include multiple different storage units and/or devices. The multiple different storage units and/or devices may or may not be of the same type or located at the same physical site. Furthermore, data repository 160 may be implemented or executed on the same computing system as the other components of system 100. Additionally, or alternatively, data repository 160 may be implemented or executed on a computing system separate from the other components of system 100. The data repository 160 may be communicatively coupled to the other components of system 100 via a direct connection or via a network.

In some embodiments, the data repository 160 stores the deployment manifests for access by the risk determination model 140 and the risk explanation model 150. The data repository 160 may also store the risk determination model 140 and the risk explanation model 150. Furthermore, the data repository 160 may store multiple deployment workflows from which the critical path module 120 may select when determining a particular deployment workflow for a target deployment.

In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

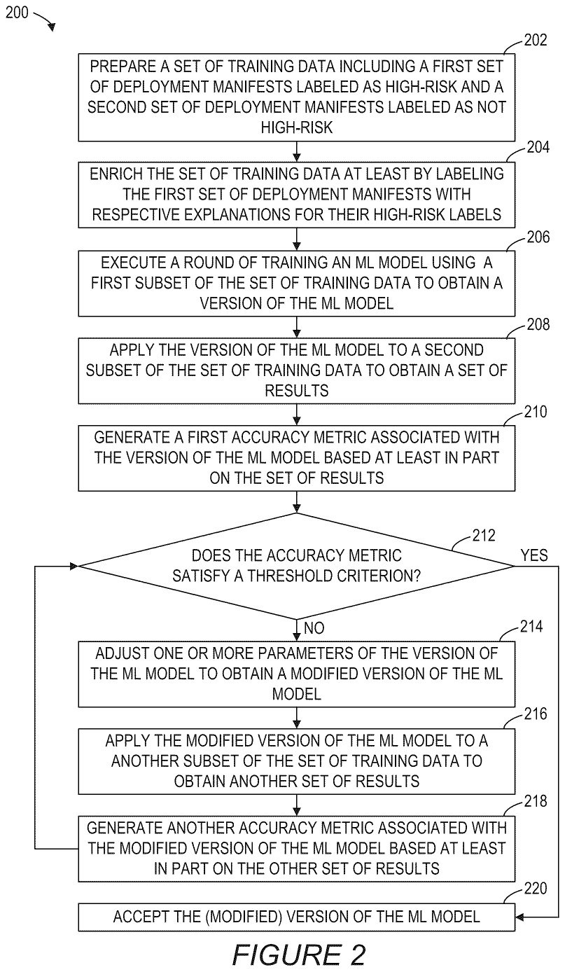

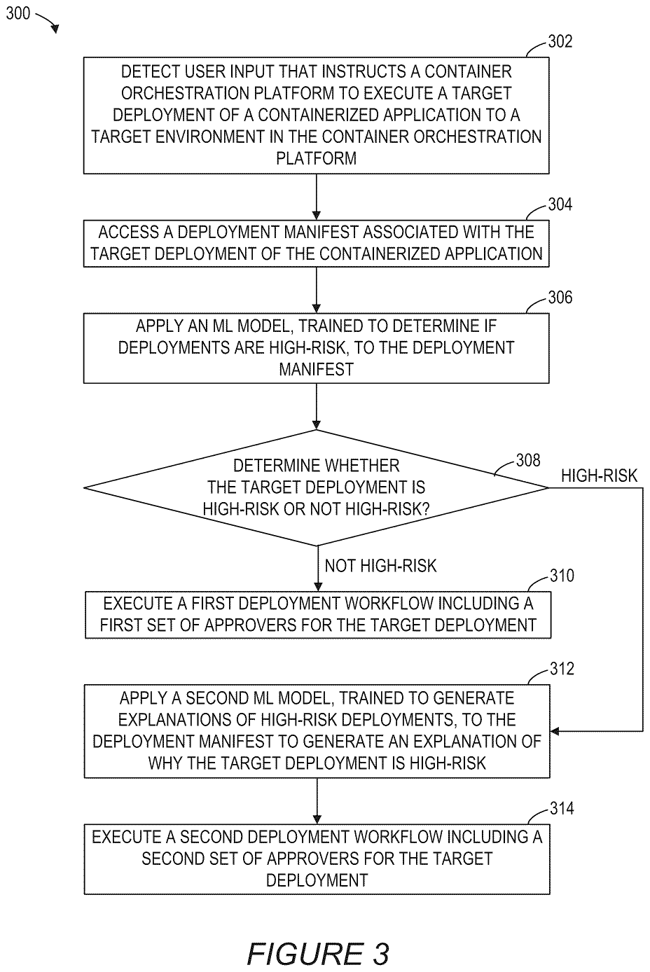

In one or more embodiments, system 100 refers to hardware and/or software configured to perform operations described herein for training an ML model to reduce the number of high-risk deployments and using an ML model to reduce the number of high-risk deployments. Examples of operations for training an ML model to reduce the number of high-risk deployments are described below with reference to FIG. 2, and example operations for using an ML model to reduce the number of high-risk deployments are described with reference to FIG. 3.

### 3. Reducing High-Risk Deployments

FIG. 2 illustrates an example set of operations 200 for training an ML model to reduce the number of high-risk deployments in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system prepares, or otherwise accesses, a set of training data including a first set of deployment manifests labeled as high-risk, and second set of deployment manifests labeled as not high-risk (Operation 202). The labeling of the deployment manifests as either high-risk or not high-risk enables the training data to be used to train the ML model to determine if a target deployment is high-risk or not high-risk. In preparing the set of training data, the system may access historical deployment manifests. In one or more embodiments, the system extracts and analyzes the resources defined within the historical deployment manifests to identify key components for evaluation. The system may compare the extracted resources against a predefined critical resources list to flag any resources considered critical. The critical resources list may include a documented list of essential assets, services, systems, or infrastructure that are vital for the successful operation of a business, project, or IT system. In an embodiment, the system constructs a labeled training dataset using historical deployment data, ensuring features, such as resource types, states, configurations, and associated criticality labels, are formatted for model ingestion.

One example of sample training data that may be prepared by the system is as follows:
Resource, Feature, Value, Criticality
Pod, spec.containers[*].image, nginx: 1.18, 1
Pod, spec.restartPolicy,OnFailure, 0
Deployment, spec.replicas, 3, 1
Deployment, spec.strategy.type, RollingUpdate, 0
StatefuleSet, spec.volumeClaimTemplates, volumeClaim1, 1
StatefulSet, spec.serviceName, stateful-service, 0

In one or more embodiments, the system enriches the set of training data at least by labeling the first set of deployment manifests with respective explanations of why the first set of deployment manifests are associated with high-risk deployments (Operation 204). The system may perform this enrichment step when preparing the training data to be used to train the ML model to generate a human-readable explanation of why a target deployment is high-risk. In an embodiment, the system may extract explanations included in the critical resources list and add the extracted explanations as labels to the corresponding deployment manifests.

One example of sample training data that has been enriched by the system is as follows:
Resource, Feature, Value, Criticality, Reason
Pod, spec. containers[*].image, nginx: 1.18, 1, “Critical because the container image is directly responsible for workload execution,”
Pod, spec.restartPolicy, OnFailure, 0, “Not critical as this policy ensures containers restart only on failure,”
Deployment, spec.replicas, 3, 1, “Critical because insufficient replicas may lead to service downtime,”
Deployment, spec.strategy.type, RollingUpdate, 0, “Not critical because deployment strategy is non-critical for small applications,”
StatefuleSet, spec.volumeClaimTemplates, volumeClaim1, 1, “Critical because volume claims ensure state persistence for workloads,”
StatefulSet, spec.serviceName, stateful-service, 0, “Not critical as serviceName is primarily used for routing, not stability.”

In some embodiments, the system executes a round of training the ML model using a first subset of the set of training data to obtain a version of the ML model (Operation 206). The system may use a gradient-boosting algorithm to train the ML model. In one or more embodiments, the system uses the gradient-boosting algorithm to train the ML model to generate a binary output indicating if a particular target deployment is high-risk. The binary output may have two possible values; one possible value indicates that the particular target deployment is high-risk, while the other possible value indicates that the particular target deployment is not high-risk. The system may use the set of training data to train the risk determination model 140 and/or the risk explanation model 150. In some embodiments, the system trains the risk determination model 140 using a version of the training data that is not enriched with respective explanations of why some of all of the deployment manifests in the training data are associated with high-risk deployments. The system may train the risk explanation model 150 using another version of the training data that is enriched with respective explanations of why some or all of the deployment manifests in the training data are associated with high-risk deployments.

In an embodiment, the system applies the version of the ML model to a second subset of the set of training data to obtain a set of results (Operation 208). In embodiments in which the system is training risk determination model 140 and risk explanation model 150, the system may generate corresponding sets of results for risk determination model 140 and risk explanation model 150.

In one or more embodiments, the system generates, based at least in part on the set of results, an accuracy metric associated with the version of the ML model (Operation 210). For example, the system may generate SHapley Additive exPlanations (SHAP) values to explain the influence of each feature on the predictions, enabling transparent model interpretability. SHAP values are a unified measure of feature importance in machine learning, providing insights into how each feature contributes to a model's prediction. The system uses the accuracy metric to evaluate the accuracy of the ML model.

In some embodiments, the system determines if the accuracy metric satisfies a threshold criterion (Operation 212). The threshold criterion may include a minimum threshold value. For example, the system may determine that the accuracy metric (e.g., SHAP value) satisfies the threshold criterion if the accuracy metric is equal to or greater than the minimum threshold value.

In one or more embodiments, responsive to determining that the accuracy metric satisfies the threshold criterion, the system accepts the version of the ML model (Operation 220). The ML model is then available for use. For example, if the ML model is the risk determination model 140, then the risk determination model 140 may then be used to determine if a target deployment is high-risk. If the ML model is the risk explanation model 150, then the risk explanation model 150 may then be used to generate explanations of why a target deployment is high-risk. The version of the ML model and corresponding accuracy metric (e.g., SHAP values) may be stored for future use, ensuring reusability and ease of deployment.

In an embodiment, responsive to determining that the accuracy metric does not satisfy a threshold criterion, the system adjusts one or more parameters of the version of the ML model to obtain a modified version of the ML model (Operation 214). For example, the system may perform hyperparameter tuning, selecting optimal values for parameters that control the ML model's learning process. Examples of hyperparameter tuning include gradient-based optimization, grid search, random search, and Bayesian optimization. Other techniques for adjusting the parameters of the version of the ML model are also within the scope of the present disclosure.

In one or more embodiments, the system applies the modified version of the ML model to the second subset of the set of training data to obtain another set of results (Operation 216). Here, the system is essentially repeating Operation 208, except that it uses the modified version of the ML model instead of the original version of the ML model.

In some embodiments, the system generates, based at least in part on the other set of results, another accuracy metric associated with the modified version of the ML model (Operation 218). Similar to Operation 210, the system may generate SHAP values to evaluate the accuracy of the modified version of the ML model.

In an embodiment, the system returns to operation 212 to determine if the other accuracy metric satisfies the threshold criterion. The system may repeat the adjustment of parameters (Operation 214), the obtaining of another set of results (Operation 216), and the generation of another accuracy metric (Operation 218) until the system determines that the other accuracy metric satisfies the threshold criterion.

At the completion of the set of operations 200, the system has trained an ML model, the risk determination model 140, to determine if a target deployment is high-risk. The system has also trained another ML model, the risk explanation model 150, to generate an explanation of why a target deployment is high-risk.

FIG. 3 illustrates an example set of operations 300 for using an ML model to reduce the number of high-risk deployments in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, the system detects user input that instructs a container orchestration platform to execute a target deployment of a containerized application to a target environment of the container orchestration platform (Operation 302). For example, the system may receive, via interface 170 of the deployment service 110, user input that defines a deployment configuration for the target deployment. The deployment configuration may be included in a deployment manifest associated with the target deployment. The user input may include an instruction to create a release for the containerized application based on the deployment configuration.

In one or more embodiments, the system accesses the deployment manifest associated with the target deployment of the containerized application (Operation 304). The system may extract features from the deployment manifest for use in evaluating the target deployment. The system may prepare the extracted features for evaluation by an ML model. For example, the system may format the extracted features into an appropriate format for input into the ML model. One example of sample evaluation data that may be prepared by the system for input into the ML model is as follows:
Resource, CriticalField, Value
Pod, spec.containers[*].image, nginx: 1.19
Pod, spec.restartPolicy, Always
Deployment, spec.replicas, 3
Deployment, spec.strategy.type, Ramped
StatefulSet, spec.volumeClaimTemplates, volumeClaim1
StatefuleSet, spec.serviceName, stateful-app
Service, spec.ports[*].port, 8080
Service, spec.selector, app=nginx
Ingress, spec.rules[*].http.paths[*].backend.service.name, backend-service
Ingress, spec.backend.service.port, 443
Job, spec.parallelism, 2
Job, spec.ttlSecondsAfterFinished, 3600

In some embodiments, the system applies a first ML model, trained to determine if deployments are high-risk, to the deployment manifest of the target deployment to determine if the target deployment is high-risk (Operation 306). For example, the system may input the evaluation data of the deployment manifest into risk determination model 140 to determine if the target deployment is high-risk.

In an embodiment, the system determines if the target deployment is high-risk or not high-risk based on the output of the first ML model (Operation 308). If the system determines that the target deployment is not high-risk, then the system executes a first deployment workflow (Operation 310). The first deployment workflow may include a first set of approvers for the target deployment. For example, as part of executing the first deployment workflow, the system may prompt one or more approvers to approve the target deployment and require that the one or more approvers approve the target deployment before proceeding with the target deployment of the containerized application to the target environment. In some embodiments, the first set of approvers is an empty set, and the system determines that the first target deployment can proceed without requiring human approval. As a result, the system performs the target deployment of the containerized application to the target environment without human approval.

In some embodiments, if the system determines that the target deployment is high-risk, then the system applies a second machine learning model, trained to generate explanations of high-risk deployments, to the deployment manifest to obtain an explanation of why the target deployment is high-risk (Operation 312). For example, the system may input the evaluation data of the deployment manifest into the risk explanation model 150 to generate the explanation.

Next, in one or more embodiments, the system executes a second deployment workflow (Operation 314). The second deployment workflow may include a second set of approvers for the target deployment. For example, as part of executing the second deployment workflow, the system may prompt one or more approvers to approve the target deployment and require that the one or more approvers approve the target deployment before proceeding with the target deployment of the containerized application to the target environment. In an embodiment, the second set of approvers of the second deployment workflow includes the first set of approvers of the first deployment workflow and at least one approver not included in the first set of approvers. The second set of approvers may also include at least one approver at an authorization level higher than that of any member of the first set of approvers for the first deployment workflow.

In some embodiments, the system incorporates the explanation of why the target deployment is high-risk, generated at Operation 312, into the execution of the second deployment workflow at Operation 314. For example, in prompting the second set of approvers to approve the target deployment, the system may present the explanation of why the target deployment is high-risk, thereby enabling the second set of approvers to efficiently and accurately evaluate the potential risk of the target deployment before deciding whether to approve or reject the target deployment. In alternative embodiments, in response to the determination, at Operation 308, that the target deployment is high-risk, the system executes the second deployment workflow, at Operation 314, without generating an explanation of why the target deployment is high-risk, skipping Operation 312.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

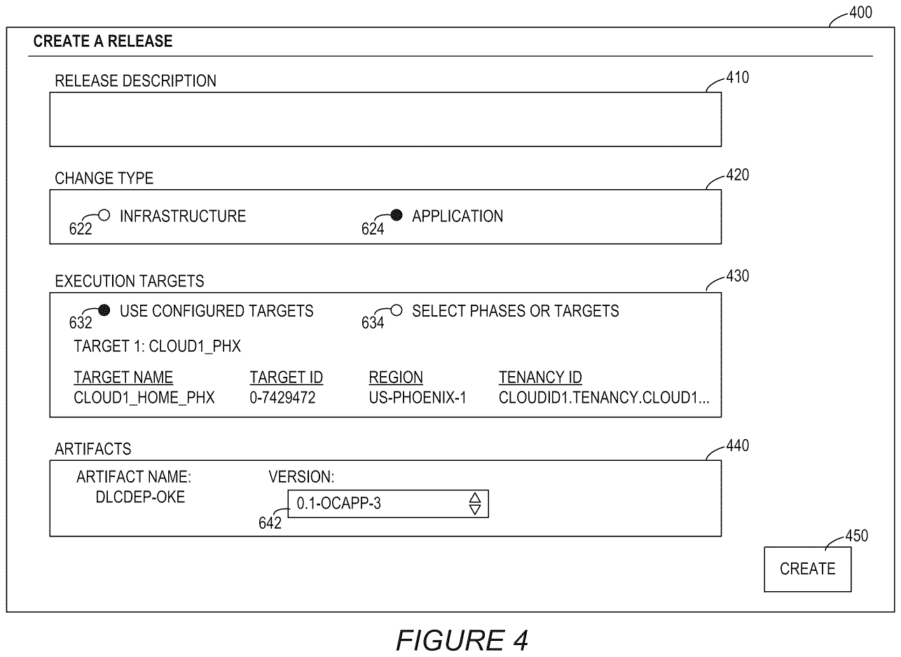

FIG. 4 illustrates an example GUI 400 for creating a software release for deployment in accordance with one or more embodiments. In some embodiments, the GUI 400 may include UI elements configured to enable the user to define a deployment configuration. For example, in FIG. 4, the GUI 400 includes a text field 410 in which the user may input a description of the software release. The GUI 400 also includes a UI element 420 configured to enable the user to define a change type for the software release. For example, the UI element 420 includes a selectable UI element 622 for the user to select in situations in which the release is directed towards infrastructure and a selectable UI element 624 for the user to select in situations in which the release is directed towards an application.

The GUI 400 further includes a UI element 430 configured to enable the user to define execution targets for the release such as details of a target environment for the target deployment. For example, the UI element 430 includes a selectable UI element 632 for the user to select in situations in which the user wants to use a preconfigured target environment for the target deployment and a selectable UI element 634 for the user to select in situations in which the user wants to select the target environment for the target deployment. The selectable UI element 634 may be configured, in response to its selection by the user, to prompt the user to select a target environment for the target deployment, such as by presenting a list of selectable target environments or providing a text field in which the user may enter the target environment.

The GUI 400 may also include a UI element 440 configured to enable the user to define artifacts for the target deployment. For example, the UI element 440 may include a UI element 642 configured to enable the user to select a particular version of an artifact for use in the target deployment. Other UI elements and deployment configuration options are also within the scope of the present disclosure.

In an embodiment, the GUI 400 includes a selectable UI element 450 configured to trigger the creation of the software release in response to its selection. For example, the UI element 450 may be configured to create a corresponding deployment manifest based on the deployment configuration defined by the user via the GUI 400. Additionally, the selection of the UI element 450 may cause the communication of an instruction to a container orchestration platform to execute a target deployment of a containerized application to a target environment of the container orchestration platform in accordance with the deployment configuration defined by the user. In response to this instruction, the container orchestration platform may execute the set operations 300 in FIG. 3.

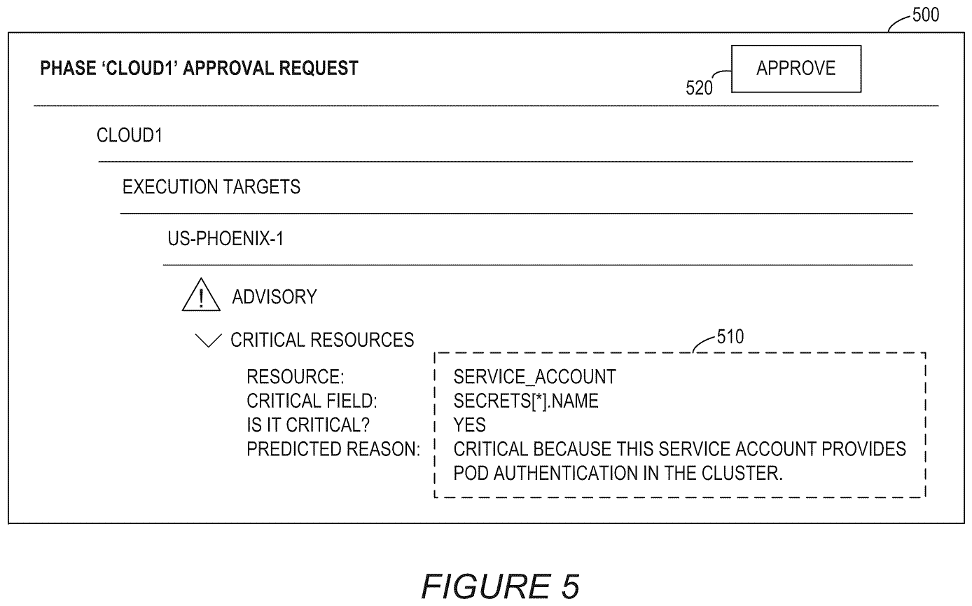

FIG. 5 illustrates an example GUI 500 for alerting a user to the existence of a high-risk deployment in accordance with one or more embodiments. The GUI 500 may be presented, or otherwise caused to be displayed, to the user as part of a deployment workflow associated with a determination that a target deployment is high-risk. For example, in FIG. 5, the GUI 500 includes information 510 regarding a target deployment that has been determined to be high-risk. The information 510 includes an identification of a critical resource that has been predicted by the system to be at risk based on an evaluation by the risk determination model 140. The information 510 also includes an identification of a critical field that has been predicted by the system to be at risk based on an evaluation by the risk determination model 140. Additionally, the information further includes the predicted reason for the determination that the target deployment is high-risk. In one or more embodiments, the predicted reason includes an explanation generated by the risk explanation model 150.

In FIG. 5, the GUI 500 also includes a selectable UI element 520 configured to enable the user to approve the target deployment. In some embodiment, the system proceeds with the target deployment in response to the required set of approvers approving the target deployment. For example, in response to the target deployment being approved by the required approvers, the system may push the application to a production environment, thereby making the application available to end-users.

### 5. Practical Applications, Advantages, and Improvements

One or more embodiments reduce the number of high-risk deployments that negatively impact critical resources. Reducing the number of such deployments improves the functioning of the computer system in at least the following ways.

When a critical resource is negatively impacted, the target environment does not function as intended. For example, an application, service, and/or data repository in the target environment may not function as intended. Thus, one or more embodiments improve the functioning of the computer system by helping to ensure that the target environment functions as intended.

Deleting or misconfiguring a critical resource and/or a resource on which a critical resource depends may introduce a security vulnerability. For example, the deployment may delete or misconfigure a credential database or firewall. One or more embodiments improve the functioning of the computer system by preventing such security vulnerabilities.

When a critical resource is negatively impacted, additional computing resources (e.g., processor cycles, memory, and/or network bandwidth) are needed to roll back the deployment and return the target environment to a state where the critical resource functions correctly. By proactively identifying high-risk deployments, one or more embodiments avoid consuming those computing resources, making them available for other processes. Thus, one or more embodiments improve the functioning of the computer system by requiring fewer computing resources overall.

### 6. Machine Learning Architecture

FIG. 6 illustrates a machine learning engine 600 in accordance with one or more embodiments. As illustrated in FIG. 6, machine learning engine 600 includes input/output module 602, data preprocessing module 604, model selection module 606, training module 608, evaluation and tuning module 610, and inference module 612.

In accordance with an embodiment, input/output module 602 serves as the primary interface for data entering and exiting the system, managing the flow and integrity of data. This module may accommodate a wide range of data sources and formats to facilitate integration and communication within the machine learning architecture.

In an embodiment, an input handler within input/output module 602 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 602 to be versatile in different operational contexts, whether processing historical datasets or streaming data.

In accordance with an embodiment, input/output module 602 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 602 includes an output framework designed to handle the distribution and exportation of outputs, predictions, or insights. Using the output framework, input/output module 602 formats these outputs into user-friendly and accessible formats, such as reports, visualizations, or data files compatible with other systems. Input/output module 602 also ensures secure and efficient transmission of these outputs to end-users or other systems in an embodiment and may employ encryption and secure data transfer protocols to maintain data confidentiality.

In accordance with an embodiment, data preprocessing module 604 transforms data into a format suitable for use by other modules in machine learning engine 600. For example, data preprocessing module 604 may transform raw data into a normalized or standardized format suitable for training ML models and for processing new data inputs for inference. In an embodiment, data preprocessing module 604 acts as a bridge between the raw data sources and the analytical capabilities of machine learning engine 600.

In an embodiment, data preprocessing module 604 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 604 may be configured to handle anomalies in different ways depending on context. Data preprocessing module 604 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 604 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 604 processes new data for inference, data preprocessing module 604 replicates the same preprocessing steps to ensure consistency with the training data format. This helps to avoid discrepancies between the training data format and the inference data format, thereby reducing the likelihood of inaccurate or invalid model predictions.

In an embodiment, model selection module 606 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 606 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 606 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 606 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 606 also considers computational efficiency and resource constraints. This is meant to help ensure the selected model is both accurate and practical in terms of computational and time requirements. In an embodiment, certain features of model selection module 606 are configurable such as a configured bias toward (or against) computational efficiency.

In accordance with an embodiment, training module 608 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 608 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 608 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 608 includes logic to handle different types of data and learning tasks. For instance, it includes different training routines for supervised learning (where the training data comes with labels) and unsupervised learning (without labeled data). In the case of deep learning models, training module 608 also manages the complexities of training neural networks that include initializing network weights, choosing activation functions, and setting up neural network layers.

In an embodiment, evaluation and tuning module 610 incorporates dynamic feedback mechanisms and facilitates continuous model evolution to help ensure the system's relevance and accuracy as the data landscape changes. Evaluation and tuning module 610 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 610 performs continuous model tuning by using hyperparameter optimization. Evaluation and tuning module 610 performs an exploration of the hyperparameter space using algorithms, such as grid search, random search, or more sophisticated methods like Bayesian optimization. Evaluation and tuning module 610 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 610 integrates data feedback and updates the model. Evaluation and tuning module 610 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 610 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 610 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 612 transforms data raw data into actionable, precise, and contextually relevant predictions. In addition to processing and applying a trained model to new data, inference module 612 may also include post-processing logic that refines the raw outputs of the model into meaningful insights.

In an embodiment, inference module 612 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 612 transforms the outputs of a trained model into definitive classifications. Inference module 612 employs the underlying model as a tool to generate probabilistic outputs for each potential class. It then engages in an interpretative process to convert these probabilities into concrete class labels.

In an embodiment, when inference module 612 receives the probabilistic outputs from the model, it analyzes these probabilities to determine how they are distributed across some or every potential class. If the highest probability is not significantly greater than the others, inference module 612 may determine that there is ambiguity or interpret this as a lack of confidence displayed by the model.

In an embodiment, inference module 612 uses thresholding techniques for applications where making a definitive decision based on the highest probability might not suffice due to the critical nature of the decision. In such cases, inference module 612 assesses if the highest probability surpasses a certain confidence threshold that is predetermined based on the specific requirements of the application. If the probabilities do not meet this threshold, inference module 612 may flag the result as uncertain or defer the decision to a human expert. Inference module 612 dynamically adjusts the decision thresholds based on the sensitivity and specificity requirements of the application, subject to calibration for balancing the trade-offs between false positives and false negatives.

In accordance with an embodiment, inference module 612 contextualizes the probability distribution against the backdrop of the specific application. This involves a comparative analysis, especially in instances where multiple classes have similar probability scores, to deduce the most plausible classification. In an embodiment, inference module 612 may incorporate additional decision-making rules or contextual information to guide this analysis, ensuring that the classification aligns with the practical and contextual nuances of the application.

In regression models, where the outputs are continuous values, inference module 612 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 612 incorporates domain-specific adjustments into its post-processing routine. This involves tailoring the model's output to align with specific industry knowledge or contextual information. For example, in financial forecasting, inference module 612 may adjust predictions based on current market trends, economic indicators, or recent significant events, ensuring that the outputs are both statistically accurate and practically relevant.

In an embodiment, inference module 612 includes logic to handle uncertainty and ambiguity in the model's predictions. In cases where inference module 612 outputs a measure of uncertainty, such as in Bayesian inference models, inference module 612 interprets these uncertainty measures by converting probabilistic distributions or confidence intervals into a format that can be easily understood and acted upon. This provides users with both a prediction and an insight into the confidence level of that prediction. In an embodiment, inference module 612 includes mechanisms for involving human oversight or integrating the instance into a feedback loop for subsequent analysis and model refinement.

In an embodiment, inference module 612 formats the final predictions for end-user consumption. Predictions are converted into visualizations, user-friendly reports, or interactive interfaces. In some systems, like recommendation engines, inference module 612 also integrates feedback mechanisms, where user responses to the predictions are used to continually refine and improve the model, creating a dynamic, self-improving system.

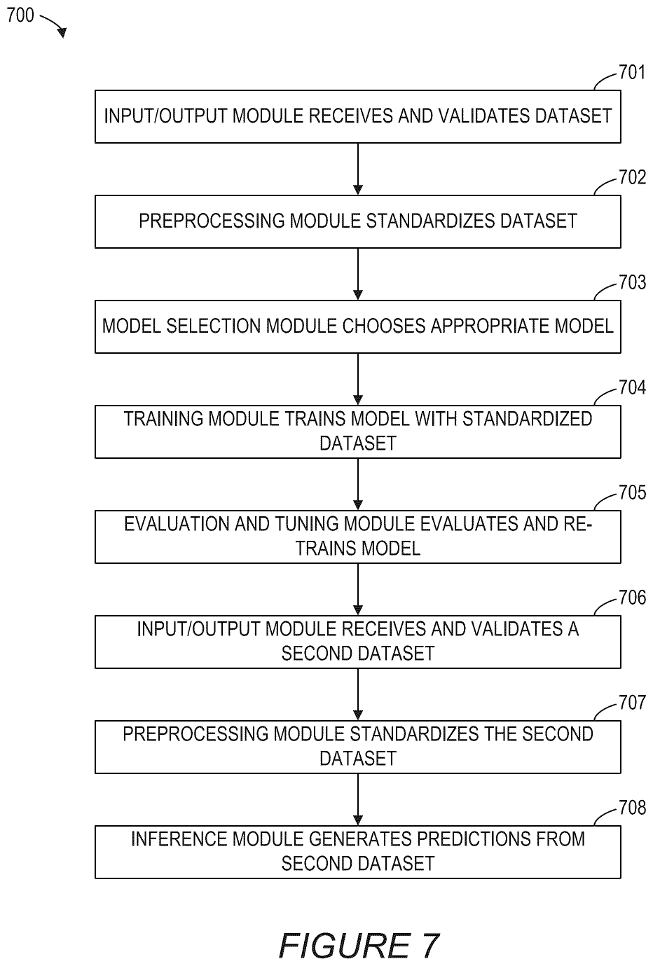

FIG. 7 illustrates the operation of a machine learning engine in one or more embodiments. In an embodiment, input/output module 602 receives a dataset intended for training (Operation 701). This data can originate from diverse sources, like databases or real-time data streams, and in varied formats, such as CSV, JSON, or XML. Input/output module 602 assesses and validates the data, ensuring its integrity by checking for consistency, data ranges, and types.

In an embodiment, training data is passed to data preprocessing module 604. Here, the data undergoes a series of transformations to standardize and clean it, making it suitable for training ML models (Operation 702). This involves normalizing numerical data, encoding categorical variables, and handling missing values through techniques like imputation.

In an embodiment, prepared data from the data preprocessing module 604 is then fed into model selection module 606 (Operation 703). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 608 trains the selected model with the prepared dataset (Operation 704). It implements learning algorithms to adjust the model's internal parameters, optimizing them to identify patterns and relationships in the training data. Training module 608 also addresses the challenge of overfitting by implementing techniques, like regularization and early stopping, ensuring the model's generalizability.

In an embodiment, evaluation and tuning module 610 evaluates the trained model's performance using the validation dataset (Operation 705). Evaluation and tuning module 610 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 602 receives a dataset intended for inference. Input/output module 602 assesses and validates the data (Operation 706).

In an embodiment, data preprocessing module 604 receives the validated dataset intended for inference (Operation 707). Data preprocessing module 604 ensures that the data format used in training is replicated for the new inference data, maintaining consistency and accuracy for the model's predictions.

In an embodiment, inference module 612 processes the new data set intended for inference, using the trained and tuned model (Operation 708). It applies the model to this data, generating raw probabilistic outputs for predictions. Inference module 612 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 620 allows for applications to leverage machine learning engine 600. In an embodiment, machine learning engine API 620 may be built on a RESTful architecture and offer stateless interactions over standard HTTP/HTTPS protocols. Machine learning engine API 620 may feature a variety of endpoints, each tailored to a specific function within machine learning engine 600. In an embodiment, endpoints such as /submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 620 is equipped to support SOAP-based interactions. This extension involves defining a WSDL (Web Services Description Language) document that outlines the API's operations and the structure of request and response messages. In an embodiment, machine learning engine API 620 supports various data formats and communication styles. In an embodiment, machine learning engine API 620 endpoints may handle requests in JSON format or any other suitable format. For example, machine learning engine API 620 may process XML, and it may also be engineered to handle more compact and efficient data formats, such as Protocol Buffers or Avro, for use in bandwidth-limited scenarios.

In an embodiment, machine learning engine API 620 is designed to integrate WebSocket technology for applications necessitating real-time data processing and immediate feedback. This integration enables a continuous, bi-directional communication channel for a dynamic and interactive data exchange between the application and machine learning engine 100.

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 602, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 604 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 606, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 608, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 610 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 612, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. Examples of Cloud Infrastructure

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
cid1.<RESOURCE TYPE>.<REALM>.[REGION][.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

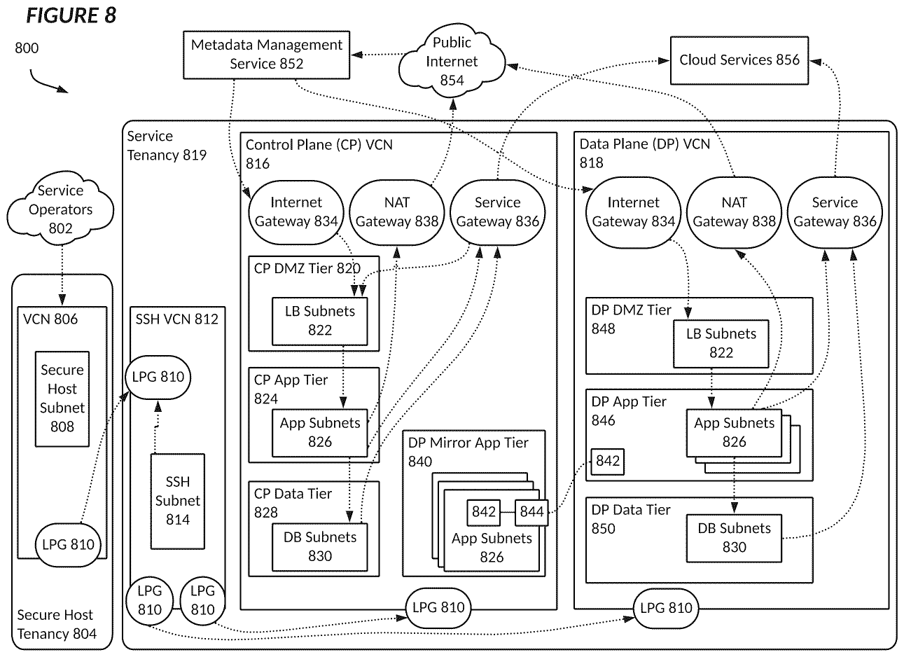

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 implemented in the SSH VCN 812. The SSH VCN 812 can include an SSH subnet 814, and the SSH VCN 812 can be communicatively coupled to a control plane VCN 816 via the LPG 810 implemented in the control plane VCN 816. Also, the SSH VCN 812 can be communicatively coupled to a data plane VCN 818 via an LPG 810. The control plane VCN 816 and the data plane VCN 818 can be implemented in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 in the control plane DMZ tier 820 can be communicatively coupled to the app subnet(s) 826 in the control plane app tier 824 and an Internet gateway 834 that can be implemented in the control plane VCN 816. The app subnet(s) 826 can be communicatively coupled to the DB subnet(s) 830 implemented in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 implemented in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be implemented in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way; the service gateway 836 can make API calls to cloud services 856, and cloud services 856 can send requested data to the service gateway 836. However, cloud services 856 may not initiate API calls to the service gateway 836.

In some examples, the secure host tenancy 804 can be directly connected to the service tenancy 819. The service tenancy 819 may otherwise be isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision resources. Resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be implemented in the data plane mirror app tier 840 and the data plane app tier 846.

In some examples, users or customers, of the system, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 implemented in the control plane DMZ tier 820. The LB subnet(s) 822 may determine that the request is valid, and in response, the LB subnet(s) 822 can transmit the request to app subnet(s) 826 implemented in the control plane app tier 824. If the request is validated and requires a call to public Internet 854, the call to public Internet 854 may be transmitted to the NAT gateway 838 that can make the call to public Internet 854. Metadata to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to a configuration may need to be applied to the resources implemented in the data plane VCN 818. Via a VNIC 842, the control plane VCN 816 can directly communicate with, and can thereby execute the changes, updates, or other suitable modifications to configuration to, resources implemented in the data plane VCN 818.

In some embodiments, the control plane VCN 816 and the data plane VCN 818 can be implemented in the service tenancy 819. In this case, the user, or the customer, of the system may not own or operate either the control plane VCN 816 or the data plane VCN 818. Instead, the IaaS provider may own or operate the control plane VCN 816 and the data plane VCN 818. The control plane VCN 816 and the data plane VCN 818 may be implemented in the service tenancy 819. This embodiment can enable isolation of networks that may prevent users or customers from interacting with other users', or other customers', resources. Also, this embodiment may allow users, or customers, of the system to store databases privately without needing to rely on public Internet 854, that may not have a sufficient level of threat protection, for storage.

In other embodiments, the LB subnet(s) 822 implemented in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may need this embodiment since database(s) that the customers use may be controlled by the IaaS provider and may be stored on the service tenancy 819. The service tenancy 819 may be isolated from public Internet 854.

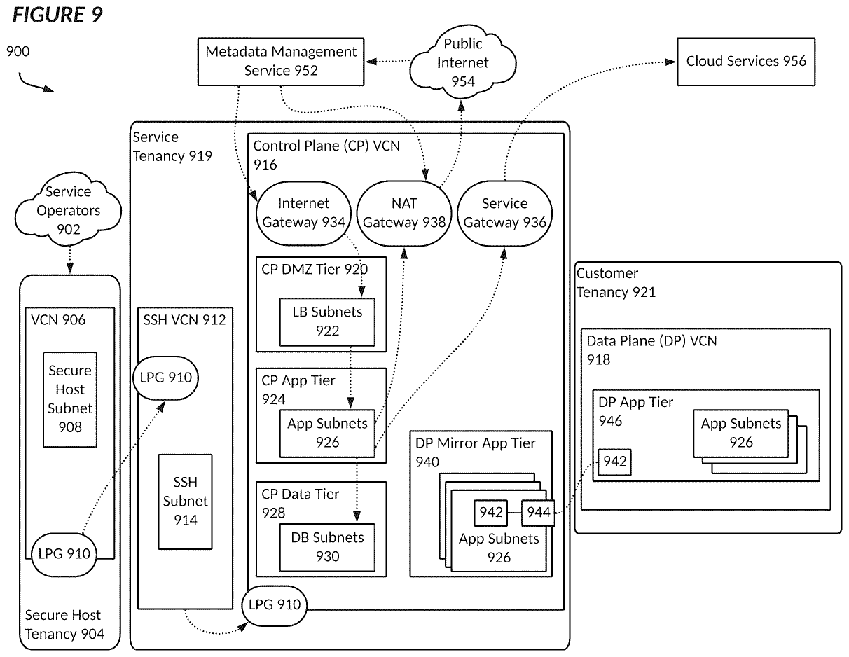

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 910 implemented in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 implemented in the control plane VCN 916. The control plane VCN 916 can be implemented in a service tenancy 919 (e.g., the service tenancy 819 of FIG. 8), and the data plane VCN 918 (e.g., the data plane VCN 818 of FIG. 8) can be implemented in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), and a control plane data tier 928 (e.g., the control plane data tier 828 of FIG. 8) that can include database (DB) subnet(s) 930 (e.g., similar to DB subnet(s) 830 of FIG. 8). The LB subnet(s) 922 implemented in the control plane DMZ tier 920 can be communicatively coupled to the app subnet(s) 926 implemented in the control plane app tier 924 and an Internet gateway 934 (e.g., the Internet gateway 834 of FIG. 8) that can be implemented in the control plane VCN 916. The app subnet(s) 926 can be communicatively coupled to the DB subnet(s) 930 implemented in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 implemented in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be implemented in a data plane app tier 946 (e.g., the data plane app tier 846 of FIG. 8). The compute instance 944 can facilitate this communication via the VNIC 942 implemented in the data plane mirror app tier 940 and the VNIC 942 implemented in the data plane app tier 946.

The Internet gateway 934 implemented in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 implemented in the control plane VCN 916. The service gateway 936 implemented in the control plane VCN 916 can be communicatively couple to cloud services 956 (e.g., cloud services 856 of FIG. 8).

In some examples, the data plane VCN 918 can be implemented in the customer tenancy 921. In this case, the IaaS provider may provide the control plane VCN 916 for a customer, and the IaaS provider may, for a customer, set up a unique, compute instance 944 that is implemented in the service tenancy 919. A compute instance 944 may allow communication between the control plane VCN 916 implemented in the service tenancy 919 and the data plane VCN 918 that is implemented in the customer tenancy 921. The compute instance 944 may allow resources provisioned in the control plane VCN 916 that is implemented in the service tenancy 919 to be deployed or otherwise used in the data plane VCN 918 that is implemented in the customer tenancy 921.

In other examples, the customer of the IaaS provider may have databases that are implemented in the customer tenancy 921. In this example, the control plane VCN 916 can include the data plane mirror app tier 940 that can include app subnet(s) 926. The data plane mirror app tier 940 can be implemented in the control plane VCN 916, but the data plane mirror app tier 940 may not be implemented in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity implemented in the control plane VCN 916. The customer may need to deploy or otherwise use resources in the data plane VCN 918 that are provisioned in the control plane VCN 916, and the data plane mirror app tier 940 can facilitate the deployment or other usage of resources of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, implemented in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be active or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 1” may be located in Region 1 and in “Region 2.” If a call to Deployment 1 is made by the service gateway 936 implemented in the control plane VCN 916 located in Region 1, the call may be transmitted to Deployment 1 in Region 1. In this example, the control plane VCN 916, or Deployment 1 in Region 1, may not be communicatively coupled to, or otherwise in communication with, Deployment 1 in Region 2.

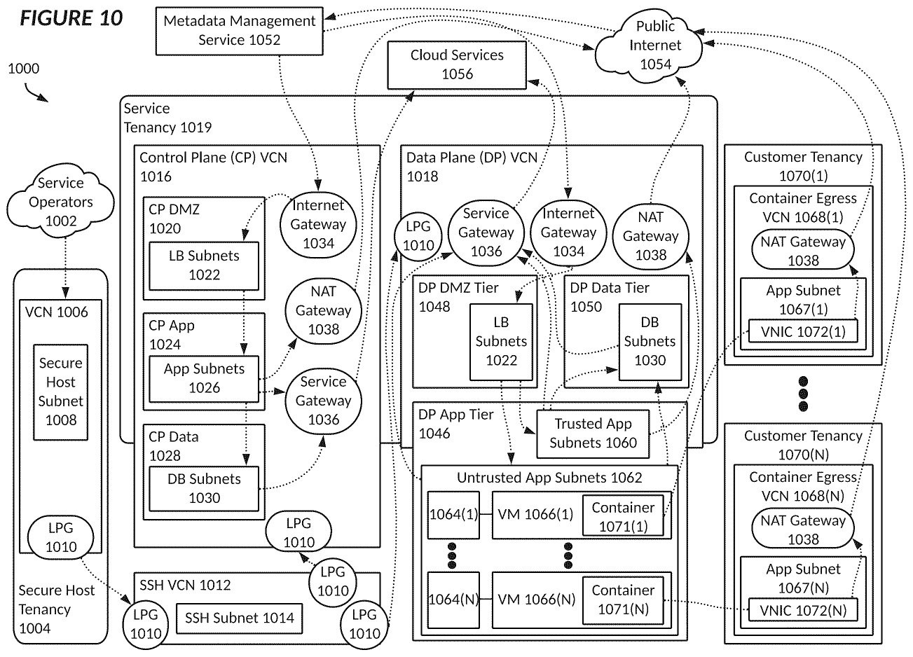

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 implemented in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 implemented in the control plane VCN 1016 and to a data plane VCN 1018 (e.g., the data plane VCN 818 of FIG. 8) via an LPG 1010 implemented in the data plane VCN 1018. The control plane VCN 1016 and the data plane VCN 1018 can be implemented in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), and a control plane data tier 1028 (e.g., the control plane data tier 828 of FIG. 8) that can include DB subnet(s) 1030. The LB subnet(s) 1022 implemented in the control plane DMZ tier 1020 can be communicatively coupled to the app subnet(s) 1026 implemented in the control plane app tier 1024 and to an Internet gateway 1034 (e.g., the Internet gateway 834 of FIG. 8) that can be implemented in the control plane VCN 1016, and the app subnet(s) 1026 can be communicatively coupled to the DB subnet(s) 1030 implemented in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060, untrusted app subnet(s) 1062 of the data plane app tier 1046, and the Internet gateway 1034 implemented in the data plane VCN 1018. The trusted app subnet(s) 1060 can be communicatively coupled to the service gateway 1036 implemented in the data plane VCN 1018, the NAT gateway 1038 implemented in the data plane VCN 1018, and DB subnet(s) 1030 implemented in the data plane data tier 1050. The untrusted app subnet(s) 1062 can be communicatively coupled to the service gateway 1036 implemented in the data plane VCN 1018 and DB subnet(s) 1030 implemented in the data plane data tier 1050. The data plane data tier 1050 can include DB subnet(s) 1030 that can be communicatively coupled to the service gateway 1036 implemented in the data plane VCN 1018.

The untrusted app subnet(s) 1062 can include one or more primary VNICs 1064(1)-(N) that can be communicatively coupled to tenant virtual machines (VMs) 1066(1)-(N). Tenant VMs 1066(1)-(N) can be communicatively coupled to a respective app subnets 1067(1)-(N) that can be implemented in respective container egress VCNs 1068(1)-(N) that can be implemented in respective customer tenancies 1070(1)-(N). Respective secondary VNICs 1072(1)-(N) can facilitate communication between the untrusted app subnet(s) 1062 implemented in the data plane VCN 1018 and the app subnet implemented in the container egress VCNs 1068(1)-(N). Container egress VCNs 1068(1)-(N) can include a NAT gateway 1038 that can be communicatively coupled to public Internet 1054 (e.g., public Internet 854 of FIG. 8).

The Internet gateway 1034 implemented in the control plane VCN 1016 and implemented in the data plane VCN 1018 can be communicatively coupled to a metadata management service 1052 (e.g., the metadata management service 852 of FIG. 8) that can be communicatively coupled to public Internet 1054. Public Internet 1054 can be communicatively coupled to the NAT gateway 1038 implemented in the control plane VCN 1016 and implemented in the data plane VCN 1018. The service gateway 1036 implemented in the control plane VCN 1016 and implemented in the data plane VCN 1018 can be communicatively couple to cloud services 1056.

In some embodiments, the data plane VCN 1018 can be integrated with customer tenancies 1070(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 1046. Code to execute the function may be executed in the VMs 1066(1)-(N), and the code may not be configured to execute anywhere else on the data plane VCN 1018. VMs 1066(1)-(N) may be connected to one customer tenancy 1070(1). Respective containers 1071(1)-(N) implemented in the VMs 1066(1)-(N) may be configured to execute the code. In this case, there can be a dual isolation (e.g., the containers 1071(1)-(N) executing code), where the containers 1071(1)-(N) may be implemented in at least the VM 1066(1)-(N) that are implemented in the untrusted app subnet(s) 1062) that may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completing execution of the code, the IaaS provider may terminate or otherwise dispose of the containers 1071(1)-(N).

In some embodiments, the trusted app subnet(s) 1060 may execute code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be implemented in the VM 1066(1)-(N) of a customer and that may execute code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

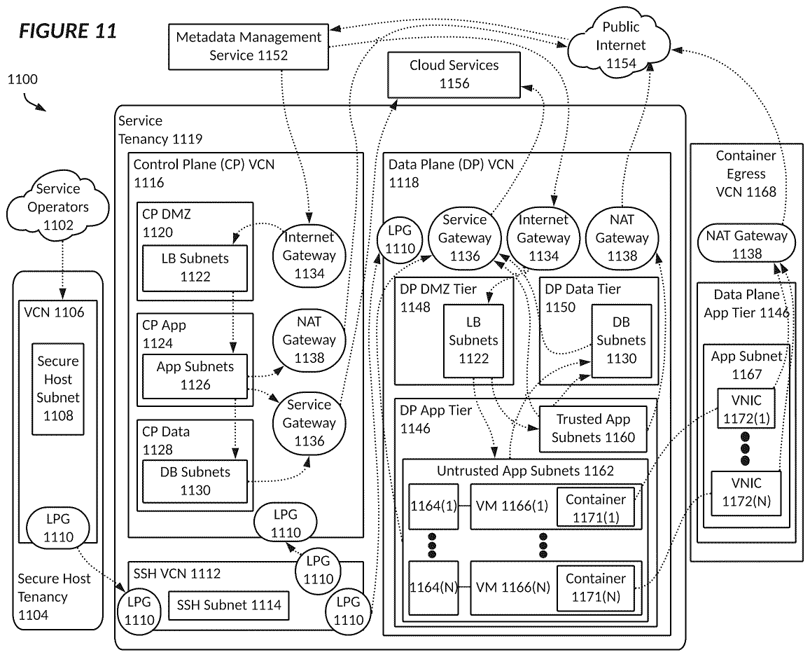

FIG. 11 is a block diagram illustrating another example pattern of an IaaS architecture 1100 according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 implemented in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 implemented in the control plane VCN 1116 and to a data plane VCN 1118 (e.g., the data plane VCN 818 of FIG. 8) via an LPG 1110 implemented in the data plane VCN 1118. The control plane VCN 1116 and the data plane VCN 1118 can be implemented in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), and a control plane data tier 1128 (e.g., the control plane data tier 828 of FIG. 8) that can include DB subnet(s) 1130 (e.g., DB subnet(s) 1030 of FIG. 10). The LB subnet(s) 1122 implemented in the control plane DMZ tier 1120 can be communicatively coupled to the app subnet(s) 1126 implemented in the control plane app tier 1124 and to an Internet gateway 1134 (e.g., the Internet gateway 834 of FIG. 8) that can be implemented in the control plane VCN 1116, and the app subnet(s) 1126 can be communicatively coupled to the DB subnet(s) 1130 implemented in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 implemented in the data plane VCN 1118. The trusted app subnet(s) 1160 can be communicatively coupled to the service gateway 1136 implemented in the data plane VCN 1118, the NAT gateway 1138 implemented in the data plane VCN 1118, and DB subnet(s) 1130 implemented in the data plane data tier 1150. The untrusted app subnet(s) 1162 can be communicatively coupled to the service gateway 1136 implemented in the data plane VCN 1118 and DB subnet(s) 1130 implemented in the data plane data tier 1150. The data plane data tier 1150 can include DB subnet(s) 1130 that can be communicatively coupled to the service gateway 1136 implemented in the data plane VCN 1118.

The untrusted app subnet(s) 1162 can include primary VNICs 1164(1)-(N) that can be communicatively coupled to tenant virtual machines (VMs) 1166(1)-(N) implemented within the untrusted app subnet(s) 1162. Tenant VMs 1166(1)-(N) can execute code in a respective container 1167(1)-(N) and be communicatively coupled to an app subnet 1167 that can be implemented in a data plane app tier 1146 that can be implemented in a container egress VCN 1168. Respective secondary VNICs 1172(1)-(N) can facilitate communication between the untrusted app subnet(s) 1162 implemented in the data plane VCN 1118 and the app subnet 1167 implemented in the container egress VCN 1168. The container egress VCN 1168 can include a NAT gateway 1138 that can be communicatively coupled to public Internet 1154 (e.g., public Internet 854 of FIG. 8).

The Internet gateway 1134 implemented in the control plane VCN 1116 and implemented in the data plane VCN 1118 can be communicatively coupled to a metadata management service 1152 (e.g., the metadata management service 852 of FIG. 8) that can be communicatively coupled to public Internet 1154. Public Internet 1154 can be communicatively coupled to the NAT gateway 1138 implemented in the control plane VCN 1116 and implemented in the data plane VCN 1118. The service gateway 1136 implemented in the control plane VCN 1116 and implemented in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be needed for a customer of the IaaS provider if the IaaS provider cannot directly communicate with the customer (e.g., a disconnected region). The respective containers 1171(1)-(N) that are implemented in the VMs 1166(1)-(N) for a customer can be accessed in real-time by the customer. The containers 1171(1)-(N) may be configured to make calls to respective secondary VNICs 1172(1)-(N) implemented in app subnet(s) 1167 of the data plane app tier 1146 that can be implemented in the container egress VCN 1168. The secondary VNICs 1172(1)-(N) can transmit the calls to the NAT gateway 1138 that may transmit the calls to public Internet 1154. In this example, the containers 1171(1)-(N) that can be accessed in real time by the customer can be isolated from the control plane VCN 1116 and can be isolated from other entities implemented in the data plane VCN 1118. The containers 1171(1)-(N) may also be isolated from resources from other customers.

In other examples, the customer can use the containers 1171(1)-(N) to call cloud services 1156. In this example, the customer may execute code in the containers 1171(1)-(N) that request a service from cloud services 1156. The containers 1171(1)-(N) can transmit this request to the secondary VNICs 1172(1)-(N) that can transmit the request to the NAT gateway 1138 that can transmit the request to public Internet 1154. Public Internet 1154 can transmit the request to LB subnet(s) 1122 implemented in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, and 1100 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for an entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. Computer System

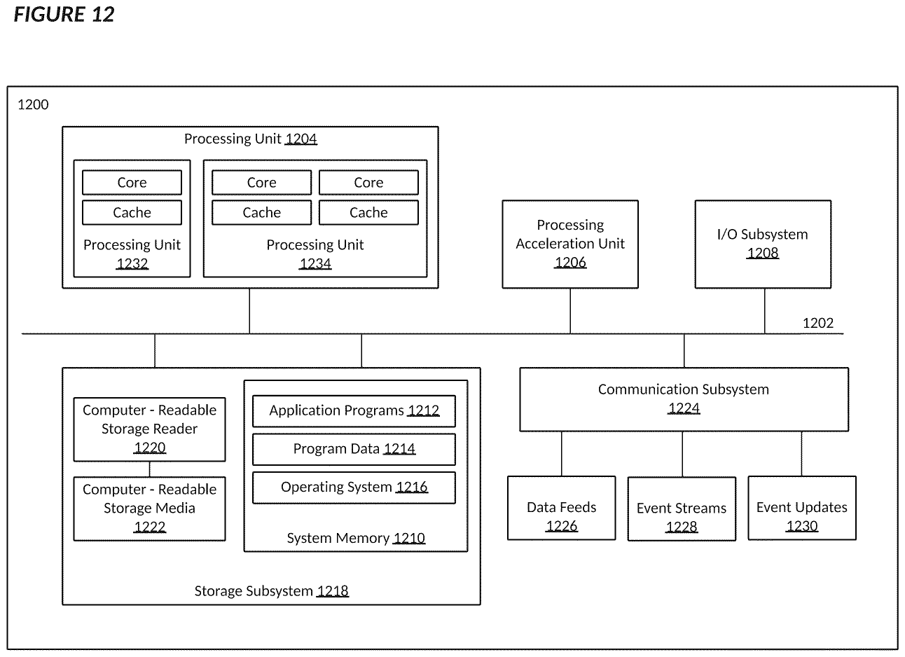

FIG. 12 illustrates an example computer system 1200. An embodiment of the disclosure may be implemented upon the computer system 1200. As shown in FIG. 12, computer system 1200 includes a processing unit 1204 that communicates with peripheral subsystems via a bus subsystem 1202. These peripheral subsystems may include a processing acceleration unit 1206, an I/O subsystem 1208, a storage subsystem 1218, and a communications subsystem 1224. Storage subsystem 1218 includes tangible computer-readable storage media 1222, computer-readable storage reader 1220 and a system memory 1210.

Bus subsystem 1202 provides a mechanism for letting the various components and subsystems of computer system 1200 to communicate with other components and subsystems as intended. Although bus subsystem 1202 is shown schematically as a single bus, alternative embodiments of the bus subsystem may utilize multiple buses. Bus subsystem 1202 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 1204 controls the operation of computer system 1200. Processing unit 1204 can be implemented as one or more integrated circuits (e.g., a conventional microprocessor or microcontroller). One or more processors may be implemented in processing unit 1204. These processors may include single core or multicore processors. In certain embodiments, processing unit 1204 may be implemented as one or more independent sub processing units 1232 and/or 1234 with single or multicore processors implemented in one or more processing units. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, the program code to be executed can be wholly or partially implemented in processing unit 1204 and/or in storage subsystem 1218. Through suitable programming, processing unit 1204 can provide various functionalities described above. Computer system 1200 may additionally include a processing acceleration unit 1206 that can include a digital signal processor (DSP), a special-purpose processor, and/or the like.

I/O subsystem 1208 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1200 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1200 may comprise a storage subsystem 1218 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1204, provide the functionality described above. Storage subsystem 1218 may also provide a repository for storing data used in accordance with the present disclosure.

As depicted in the example in FIG. 12, storage subsystem 1218 can include various components, including a system memory 1210, computer-readable storage media 1222, and a computer readable storage media reader 1220. System memory 1210 may store program instructions, such as application programs 1212, that are loadable and executable by processing unit 1204. System memory 1210 may also store data, such as program data 1214, that is used during the execution of the instructions and/or data that is generated during the execution of the program instructions. Various programs may be loaded into system memory 1210 including, but not limited to, client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1210 may include a basic input/output system (BIOS) including basic routines that help to transfer information between elements within computer system 1200 such as during start-up.

Computer-readable storage media 1222 may represent remote, local, fixed, and/or removable storage devices plus storage media for temporarily and/or more permanently including and storing computer-readable information for use by computer system 1200, including instructions executable by processing unit 1204 of computer system 1200.

Computer-readable storage media 1222 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1200.

Machine-readable instructions executable by one or more processors or cores of processing unit 1204 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments, communications subsystem 1224 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1224 may be configured to receive data in the form of continuous data streams. The continuous data streams may include event streams 1228 of real-time events and/or event updates 1230 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in FIG. 12 is intended as a non-limiting example. Many other configurations having more or fewer components than the system depicted in FIG. 12 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
accessing a first deployment manifest associated with a first target deployment of a first containerized application to a first target environment in a container orchestration platform;
applying a first machine learning model, trained to determine if deployments are high-risk based on deployment manifests, to the first deployment manifest to determine if the first target deployment is high-risk;
responsive to determining that the first target deployment is not high-risk: executing a first deployment workflow comprising a first set of approvers for the first target deployment;
accessing a second deployment manifest associated with a second target deployment of a second containerized application to a second target environment in the container orchestration platform;
applying the first machine learning model to the second deployment manifest to determine if the second target deployment is high-risk; and
responsive to determining that the second target deployment is high-risk: executing a second deployment workflow comprising a second set of approvers for the second target deployment;
wherein the second set of approvers comprises the first set of approvers and at least one approver not included in the first set of approvers; and
wherein the method is performed by at least one device including a hardware processor.

2. The method of claim 1, wherein the first set of approvers is an empty set and executing the first deployment workflow for the first target deployment comprises:
determining, by a critical path module, that the first target deployment can proceed without requiring human approval; and
performing the first target deployment to the first target environment without human approval.

3. The method of claim 1, wherein the second set of approvers comprises at least one approver at an authorization level higher than that of any member of the first set of approvers.

4. The method of claim 1:
wherein the container orchestration platform is a multi-tenant platform hosted by a cloud service provider;
wherein the first target environment is associated with a first tenant of the multi-tenant platform; and
wherein applying the first machine learning model to the first deployment manifest to determine if the first target deployment is high-risk is performed by a service provided and managed by the cloud service provider.

5. The method of claim 4, wherein the tenant is not authorized to disable the service used to determine if the first target deployment is high-risk.

6. The method of claim 1, further comprising, responsive to determining that the second target deployment is high-risk:
applying a second machine learning model, trained to generate explanations of high-risk deployments based on deployment manifests, to the second deployment manifest to obtain an explanation of why the second target deployment is high-risk; and
incorporating the explanation of why the second target deployment is high-risk into the second deployment workflow.

7. The method of claim 1:
wherein the first machine learning model is configured to use a gradient-boosting algorithm to generate a binary output indicating if a particular target deployment is high-risk;
wherein a first possible value of the binary output generated by the first machine learning model indicates that the particular target deployment is high-risk; and
wherein a second possible value of the binary output generated by the first machine learning model indicates that the particular target deployment is not high-risk.

8. The method of claim 1, further comprising:
detecting user input that instructs the container orchestration platform to execute the first target deployment;
wherein applying the first machine learning model to the first deployment manifest to determine if the first target deployment is high-risk is performed responsive to the user input.

9. The method of claim 1, further comprising:
accessing a set of training data comprising a first set of deployment manifests labeled as high-risk and second set of deployment manifests labeled as not high-risk; and
training the first machine learning model using the set of training data.

10. The method of claim 9, wherein training the first machine learning model using the set of training data comprises:
executing a first round of training of the first machine learning model using a first subset of the set of training data to obtain a first version of the first machine learning model;
applying the first version of the first machine learning model to a second subset of the set of training data to obtain a first set of results;
generating, based at least in part on the first set of results, a first accuracy metric associated with the first version of the machine learning model;
responsive to determining that the first accuracy metric does not satisfy a threshold criterion:
adjusting one or more parameters of the first version of the first machine learning model to obtain a second version of the first machine learning model;
applying the second version of the first machine learning model to the second subset of the set of training data to obtain a second set of results;
generating, based at least in part on the second set of results, a second accuracy metric associated with the second version of the first machine learning model; and
responsive to determining that the second accuracy metric satisfies the threshold criterion:
accepting the second version of the first machine learning model.

11. The method of claim 9, further comprising:
enriching the set of training data at least by labeling the first set of deployment manifests with respective explanations of why the first set of deployment manifests are associated with high-risk deployments.

12. One or more non-transitory computer-readable media storing instructions which, when executed by one or more hardware processors, cause performance of operations comprising:
accessing a first deployment manifest associated with a first target deployment of a first containerized application to a first target environment in a container orchestration platform;
applying a first machine learning model, trained to determine if deployments are high-risk based on deployment manifests, to the first deployment manifest to determine if the first target deployment is high-risk;
responsive to determining that the first target deployment is not high-risk: executing a first deployment workflow comprising a first set of approvers for the first target deployment;
accessing a second deployment manifest associated with a second target deployment of a second containerized application to a second target environment in the container orchestration platform;
applying the first machine learning model to the second deployment manifest to determine if the second target deployment is high-risk; and
responsive to determining that the second target deployment is high-risk: executing a second deployment workflow comprising a second set of approvers for the second target deployment;
wherein the second set of approvers comprises the first set of approvers and at least one approver not included in the first set of approvers.

13. The media of claim 12, wherein the first set of approvers is an empty set and executing the first deployment workflow for the first target deployment comprises:
determining that the first target deployment can proceed without requiring human approval; and
performing the first target deployment to the first target environment without human approval.

14. The media of claim 12, wherein the second set of approvers comprises at least one approver at an authorization level higher than that of any member of the first set of approvers.

15. The media of claim 12:
wherein the container orchestration platform is a multi-tenant platform hosted by a cloud service provider;
wherein the first target environment is associated with a first tenant of the multi-tenant platform; and
wherein applying the first machine learning model to the first deployment manifest to determine if the first target deployment is high-risk is performed by a service provided and managed by the cloud service provider.

16. The media of claim 15, wherein the tenant is not authorized to disable the service used to determine if the first target deployment is high-risk.

17. The media of claim 12, wherein the operations further comprise, responsive to determining that the second target deployment is high-risk:
applying a second machine learning model, trained to generate explanations of high-risk deployments based on deployment manifests, to the second deployment manifest to obtain an explanation of why the second target deployment is high-risk; and
incorporating the explanation of why the second target deployment is high-risk into the second deployment workflow.

18. The media of claim 12:
wherein the first machine learning model is configured to use a gradient-boosting algorithm to generate a binary output indicating if a particular target deployment is high-risk;
wherein a first possible value of the binary output generated by the first machine learning model indicates that the particular target deployment is high-risk; and
wherein a second possible value of the binary output generated by the first machine learning model indicates that the particular target deployment is not high-risk.

19. The media of claim 12, wherein the operations further comprise:
detecting user input that instructs the container orchestration platform to execute the first target deployment;
wherein applying the first machine learning model to the first deployment manifest to determine if the first target deployment is high-risk is performed responsive to the user input.

20. A system comprising:
one or more hardware processors;
one or more non-transitory computer-readable media; and
program instructions stored on the one or more non-transitory computer-readable media which, when executed by the one or more hardware processors, cause the system to perform operations comprising:
accessing a first deployment manifest associated with a first target deployment of a first containerized application to a first target environment in a container orchestration platform;
applying a first machine learning model, trained to determine if deployments are high-risk based on deployment manifests, to the first deployment manifest to determine if the first target deployment is high-risk;
responsive to determining that the first target deployment is not high-risk: executing a first deployment workflow comprising a first set of approvers for the first target deployment;
accessing a second deployment manifest associated with a second target deployment of a second containerized application to a second target environment in the container orchestration platform;
applying the first machine learning model to the second deployment manifest to determine if the second target deployment is high-risk; and
responsive to determining that the second target deployment is high-risk: executing a second deployment workflow comprising a second set of approvers for the second target deployment;
wherein the second set of approvers comprises the first set of approvers and at least one approver not included in the first set of approvers.
